(19) United States
(12) Patent Application Publication
(10) Pub. No.: US 2025/0299873 A1
(43) Pub. Date: Sep. 25, 2025

(54) COIL COMPONENT

(71) Applicant: TDK Corporation, Tokyo (JP)

(72) Inventors: Junichi NAKAMURA, Tokyo (JP); Yoshitomo SATO, Tokyo (JP); Ryota UCHIYAMA, Tokyo (JP); Shoma KAJIKIYA, Tokyo (JP); Toshio TOMONARI, Tokyo (JP)

(73) Assignee: TDK Corporation, Tokyo (JP)

(21) Appl. No.: 19/086,192

(22) Filed: Mar. 21, 2025

(30) Foreign Application Priority Data
Mar. 22, 2024 (JP) 2024-046552

(51) Int. Cl. H01F 27/32; H01F 1/03; H01F 5/06; H01F 17/04; H01F 27/02

(52) U.S. Cl. CPC H01F 27/324; H01F 1/0315; H01F 5/06; H01F 17/04; H01F 27/022

(57) ABSTRACT

Disclosed herein is a coil component that includes: a ferrite sintered body having a first main surface, a second main surface positioned on an opposite side of the first main surface, and a side surface connecting an outer peripheral edges of the first and second main surfaces; a coil conductor disposed so as to overlap the first main surface of the ferrite sintered body; and a resin layer covering the first and second main surfaces and at least a part of the side surface.

### CROSS-REFERENCE TO RELATED APPLICATION

This application claims the benefit of Japanese Patent Application No. 2024-046552, filed on Mar. 22, 2024, the entire disclosure of which is incorporated by reference herein.

### BACKGROUND

The present disclosure relates to a coil component.

JP 2023-184390A discloses a coil component having a structure in which a planar coil is disposed on one surface of a plate-like ferrite through a holder having magnetism.

However, the ferrite, which is a sintered body, is fragile, so that particles of the ferrite are disadvantageously diffused in an electronic device using the coil component described in JP 2023-184390A.

### SUMMARY

A coil component according to an embodiment of the present disclosure includes: a ferrite sintered body having a first main surface, a second main surface positioned on the opposite side of the first main surface, and a side surface connecting the outer peripheral edges of the first and second main surfaces; a coil conductor disposed so as to overlap the first main surface of the ferrite sintered body; and a resin layer covering the first and second main surfaces and at least a part of the side surface.

### BRIEF DESCRIPTION OF THE DRAWINGS

The above features and advantages of the present disclosure will be more apparent from the following description of some embodiments taken in conjunction with the accompanying drawings, in which:

FIG. 1 is a schematic cross-sectional view illustrating the outer appearance of a coil component 100 according to an embodiment of the present disclosure;

FIG. 2 is a schematic plan view illustrating the outer appearance of the coil component 100 which are viewed in one direction;

FIG. 3 is a schematic plan view illustrating the outer appearance of the coil component 100 which are viewed in the other direction;

FIG. 4 is an enlarged view of a region 40 illustrated in FIG. 1;

FIG. 5 is a partial cross-sectional view of a coil component according to a first modification; and

FIG. 6 is a partial cross-sectional view of a coil component according to a second modification.

### DETAILED DESCRIPTION OF THE EMBODIMENTS

The present disclosure describes a technology for suppressing the diffusion of ferrite particles in a coil component including a ferrite sintered body and a coil conductor.

Some embodiments of the present disclosure will be explained below in detail with reference the accompanying drawings.

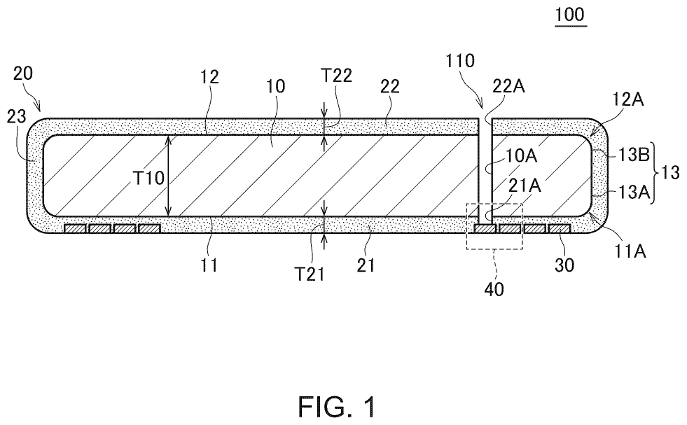

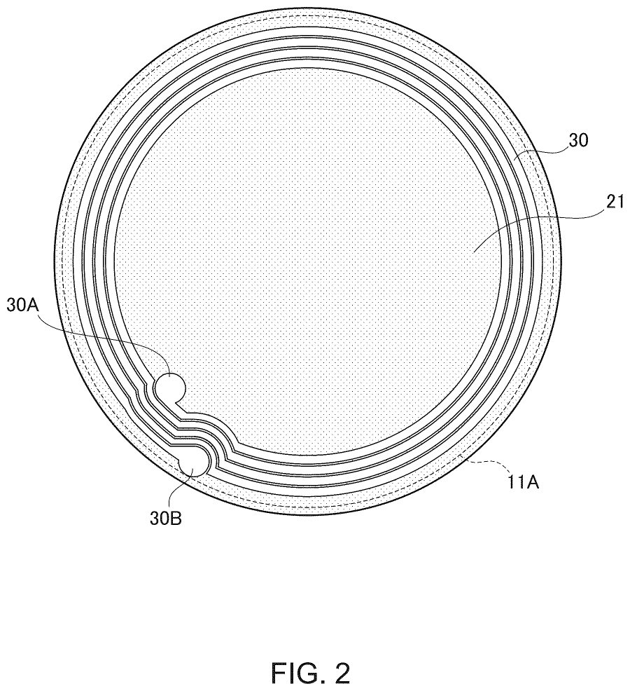

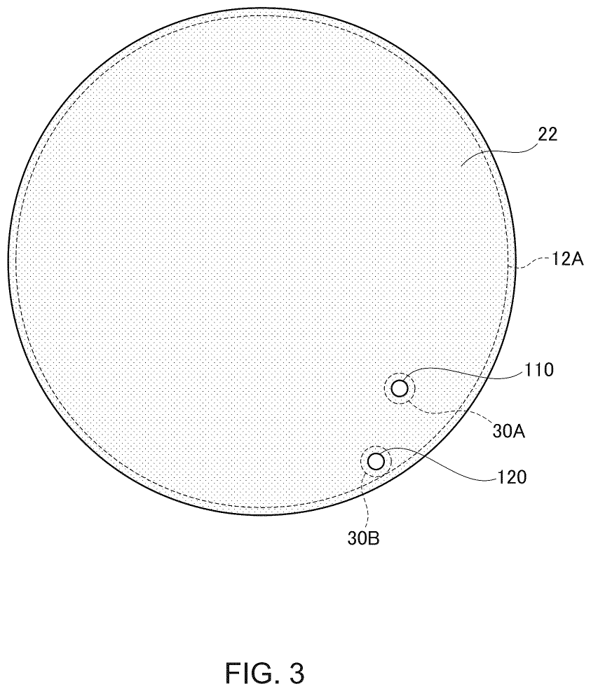

FIG. 1 is a schematic cross-sectional view illustrating the outer appearance of a coil component 100 according to an embodiment of the present disclosure. FIGS. 2 and 3 are schematic plan views illustrating the outer appearance of the coil component 100 which are viewed in the mutually opposite directions.

As illustrated in FIGS. 1 to 3, the coil component 100 according to the present embodiment has a disk shape and includes a ferrite sintered body 10, a resin layer 20 covering the surface of the ferrite sintered body 10, and a coil conductor 30. The planar shape of the coil component 100 according to the present embodiment is a substantially circular, but not particularly limited thereto and may be rectangular. The ferrite sintered body 10 functions as a magnetic path for magnetic flux generated by the coil conductor 30. The permeability of the ferrite sintered body 10 may be 100 to 200. On the other hand, the permeability of a magnetic sheet obtained by mixing metal magnetic powder in resin is about 20 to 80. As described above, in the present embodiment, the ferrite sintered body 10 is used as the magnetic path, so that the permeability becomes higher as compared with when the magnetic sheet or the like is used, thus further increasing the inductance of the coil conductor 30.

The ferrite sintered body 10 is made of a ridged, bulky ferrite material and has first and second main surfaces 11 and 12 positioned on mutually opposite sides and a side surface 13 connecting an outer peripheral edge 11A of the main surface 11 and an outer peripheral edge 12A of the main surface 12. The main surfaces 11 and 12 are substantially parallel to each other, and the main surfaces 11, 12 and side surface 13 are substantially perpendicular to each other. However, the ferrite sintered body 10 may be subjected to manufacturing error and variation, so that the main surfaces 11 and 12 need not be strictly parallel to each other, and the main surfaces 11, 12 and side surface 13 need not be strictly perpendicular to each other. Further, the outer peripheral edges 11A and 12A of the respective main surfaces 11 and 12 may be curved as illustrated in FIG. 1. A thickness T10 of the ferrite sintered body 10, i.e., the distance between the main surfaces 11 and 12 is several 10 μm, for example.

The resin layer 20 entirely covers the main surfaces 11 and 12 of the ferrite sintered body 10 and goes around to a part of the side surface 13 from the outer peripheral edges 11A and 12A of the main surface 11 to cover at least a part of the side surface 13. A part of the resin layer 20 that covers the main surface 11 of the ferrite sintered body 10 constitutes a first resin region 21, and a part of the resin layer 20 that covers the main surface 12 of the ferrite sintered body 10 constitutes a second resin region 22, and a part of the resin layer 20 that covers the side surface 13 of the ferrite sintered body 10 constitutes a third resin region 23.

A thickness T21 of the first resin region 21 of the resin layer 20 and a thickness T22 of the second resin region 22 of the resin layer 20 may both be smaller than the thickness T10 of the ferrite sintered body 10. The thickness T21 of the first resin region 21 and thickness T22 of the second resin region 22 may be 10 μm to 20 μm, for example. The thickness T21 and thickness T22 may be the same.

The first, second, and third resin regions 21, 22, and 23 of the resin layer 20 may be formed integrally. In this case, the entire surface (composed of the main surfaces 11, 12 and side surface 13) of the ferrite sintered body 10 is not exposed but covered with the resin layer 20. Alternatively, the first resin region 21 and a part of the third resin region 23 that covers a first side surface region 13A of the side surface 13 may be formed integrally, the second resin region 22 and a part of the third resin region 23 that covers a second side surface region 13B of the side surface 13 may be formed integrally, and a part of the side surface 13 of the ferrite sintered body 10 that covers the first side surface region 13A and a part of the side surface 13 of the ferrite sintered body 10 that covers the second side surface region 13B may be connected to each other. That is, the first and second resin regions 21 and 22 of the resin layer 20 may be connected to each other through the third resin region 23. However, the side surface 13 of the ferrite sintered body 10 need not entirely be covered with the resin layer 20, but a part of the side surface 13 of the ferrite sintered body 10 may be exposed without being covered with the resin layer 20. Further, although the resin layer 20 tightly adheres to the surface of the ferrite sintered body 10 in the present embodiment, there may partially be a clearance between the resin layer 20 and the surface of the ferrite sintered body 10.

As described above, a large part of or the entire surface of the ferrite sintered body 10 is covered with the resin layer 20, so that even when ferrite particles are generated, the diffusion of the particles to the outside is suppressed. The particles are more likely to be generated particularly at the outer peripheral edges 11A and 12A of the ferrite sintered body 10, and thus by covering these portions with the resin layer 20, the diffusion of the particles is effectively suppressed. Thus, even when the coil component 100 according to the present embodiment is mounted in an electronic device such as a mobile wireless terminal, the ferrite articles are unlikely to be diffused in the electronic device, thereby increasing reliability of the device.

The coil conductor 30 is disposed on the main surface 11 side of the ferrite sintered body 10 so as to be embedded in the first resin region 21 of the resin layer 20. The surface of the coil conductor 30 is exposed from the first resin region 21 of the resin layer 20, and thus the first resin region 21 of the resin layer 20 is positioned between the main surface 11 of the ferrite sintered body 10 and coil conductor 30. In the example illustrated in FIG. 2, the coil conductor 30 is spirally wound in about four turns. One end (inner peripheral end) of the coil conductor 30 constitutes a terminal part 30A, and the other end (outer peripheral end) thereof constitutes a terminal part 30A. In the example illustrated in FIG. 2, the terminal parts 30A and 30B each have a substantially circular planar shape and have a diameter larger than the pattern width of a part of the coil conductor 30 other than the terminal parts 30A and 30B.

As illustrated in FIG. 1, the coil component 100 according to the present embodiment has a through hole 110. The through hole 110 includes a first through hole 10A penetrating the ferrite sintered body 10, a second through hole 21A penetrating the first resin region 21 of the resin layer 20, and a third through hole 22A penetrating the second resin region 22 of the resin layer 20. The through hole 110 is formed at a position overlapping the terminal part 30A of the coil conductor 30, whereby the terminal part 30A of the coil conductor 30 is exposed to the bottom of the through hole 110. Another through hole 120 formed in the coil component 100 is a through hole penetrating the ferrite sintered body 10, first resin region 20 of the resin layer 20, and second resin region 22 of the resin layer 20. The through hole 120 is formed at a position overlapping the terminal part 30B of the coil conductor 30, whereby the terminal part 30B of the coil conductor 30 is exposed to the bottom of the through hole 120. With this configuration, when the coil component according to the present embodiment is mounted in an electronic device, connection to the coil conductor 30 can be made from the second resin region 22 side of the resin layer 20. The inner walls of the through holes 110 and 120 do not constitute the surface of the ferrite sintered body 10 that is covered with the resin layer 20.

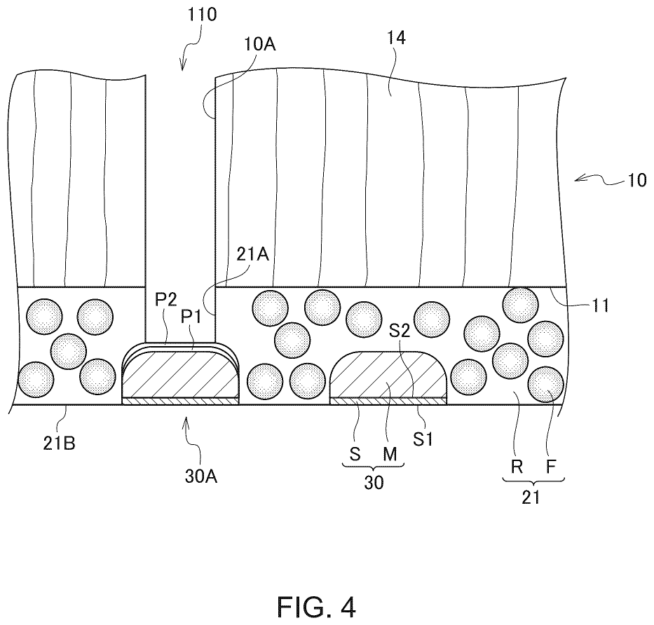

FIG. 4 is an enlarged view of a region 40 illustrated in FIG. 1.

As illustrated in FIG. 4, the coil conductor 30 is embedded in the first resin region 21 of the resin layer 20 such that a part thereof is exposed from a surface 21B of the first resin region 21 of the resin layer 20. The coil conductor 30 includes a seed part S containing resin and a main body part M stacked on a second surface S2 of the seed part S and constituted by a metal material. A first surface S1 of the seed part S is exposed from the first resin region 21 of the resin layer 20. The first and second surfaces S1 and S2 are positioned on mutually opposite sides. The coil conductor 30 may have a shape having a part reduced in radial from the seed part S toward the main body part M. The radial width refers to the width in a direction from the inner peripheral side of the coil conductor 30 toward the outer peripheral side. The coil conductor 30 is formed on the surface of a not illustrated substrate, and the substrate may be removed afterward. In this case, the substrate is not included in the coil component 100. This reduces the thickness of the coil component 100 in the coil axis direction.

The coil conductor 30 is embedded in the first resin region 21 of the resin layer 20 such that the first surface S1 of the seed part S is exposed from the surface 21B of the first resin region 21 of the resin layer 20. The metal material constituting the main body part M of the coil conductor 30 may be Cu. The seed part S may contain a material functioning as a catalyst used when the main body part M is formed by plating. The thickness of the main body part M may be larger than the seed part S. This can reduce the resistance value of the coil conductor 30.

The main body part M may entirely be embedded in the first resin region 21 of the resin layer 20 without being exposed therefrom. Alternatively, a part of the main body part M, for example, a part thereof that covers the side surface of the seed part S may be exposed from the first resin region 21 of the resin layer 20. Further, the side surface of a part of the main body part M that is stacked on the second surface S2 of the seed part S may be partially exposed from the first resin region 21 of the resin layer 20. In the example illustrated in FIG. 4, the seed part S is also embedded in the first resin region 21 of the resin layer 20, and the surface 21B of the first resin region 21 of the resin layer 20 and first surface S1 of the seed part S are flush with each other.

The first resin region 21 of the resin layer 20 includes a portion positioned between the coil conductor 30 and ferrite sintered body 10. The first resin region 21 of the resin layer 20 contains a filler particle F and a binder resin R. The filler particle F may have a spherical shape. Using the spherical filler particle F makes it unlikely to generate a clearance around the coil conductor 30 while enhancing the strength of the first resin region 21 of the resin layer 20.

The material of the filler particle F may be a nonmagnetic inorganic material such as alumina or a magnetic material such as ferrite or an Fe-based alloy magnetic material. Examples of the Fe-based alloy include permalloy, sendust, Fe—Si—Cr, Fe—Si, carbonyl iron, Fe-based alloy amorphous powder containing at least Fe—Si—B, and Fe-based alloy nanocrystalline powder containing at least Fe—B—P—Cu. When a magnetic material is used for the filler particle F, the inductance of the coil conductor 30 can be further increased. The average particle diameter (D₅₀) of the filler particle F is 2 μm to 10 μm, for example. The average particle diameter is a value of D₅₀ obtained in laser diffraction particle distribution measurement.

Examples of the material of the binder resin R include acrylic resin, polyester resin, polyethylene resin, polyvinyl chloride resin, polyvinyl butyral resin, poly urethane resin, polyester urethane resin, cellulose resin, ABS (acrylonitrile-butadiene-styrene) resin, nitrile-butadiene rubber, styrene-butadiene rubber, epoxy resin, phenol resin, amide resin, polyester elastomer, and polyamide elastomer. The elongation percentage obtained by tensile test for resin used as the binder resin R may be higher than 400%.

The second resin region 22 of the resin layer 20 may have the same configuration as that of the first resin region 21 described above. The third resin region 23 of the resin layer 20 may also have the same configuration as that of the first resin region 21 described above.

The ferrite sintered body 10 may be an aggregate of individual pieces 14 divided by cracks extending in the thickness direction (coil axis direction). This can prevent breakage of the ferrite sintered body 10. The cracks need not strictly extend in the thickness direction and may include one having an inclination with respect to the thickness direction and one extending in the plane direction. Further, the binder resin R constituting the resin layer 20 may enter the clearance (crack) between the individual pieces 14 of the ferrite sintered body 10. Thus, the individual pieces 14 are fixed to each other by the binder resin R, making it possible to enhance strength of the ferrite sintered body 10. Note that the binder resin R may enter only some clearances or only the surface layer of the ferrite sintered body 10.

As illustrated in FIG. 4, the surface of the main body part M constituting the terminal part 30A of the coil conductor 30 may be covered with plating layers P1 and P2. The plating layer P1 is formed of Ni, for example, and the plating layer P2 is formed of Au, for example. Thus, the surface of the terminal part 30A exposed to the bottom of the through hole 110 is not constituted by the main body part M (Cu) but the plating layer P2 (Au), so that reliability of the coil component 100 is increased. Although not illustrated, the surface of the main body part M constituting the terminal part 30B of the coil conductor 30 may also be covered with the plating layers P1 and P2.

As described above, in the coil component 100 according to the present embodiment, the ferrite sintered body 10 and coil conductor 30 are arranged so as to overlap each other in the axial direction, and the surface of the ferrite sintered body 10 is covered with the resin layer 20, so that the diffusion of the ferrite particles can be suppressed. In addition, the coil conductor 30 is embedded in the first resin region 21 of the resin layer 20, so that the entire thickness of the coil component 100 can be reduced.

While some embodiments of the present disclosure has been described, the present disclosure is not limited to the above embodiment, and various modifications may be made within the scope of the present disclosure, and all such modifications are included in the present disclosure.

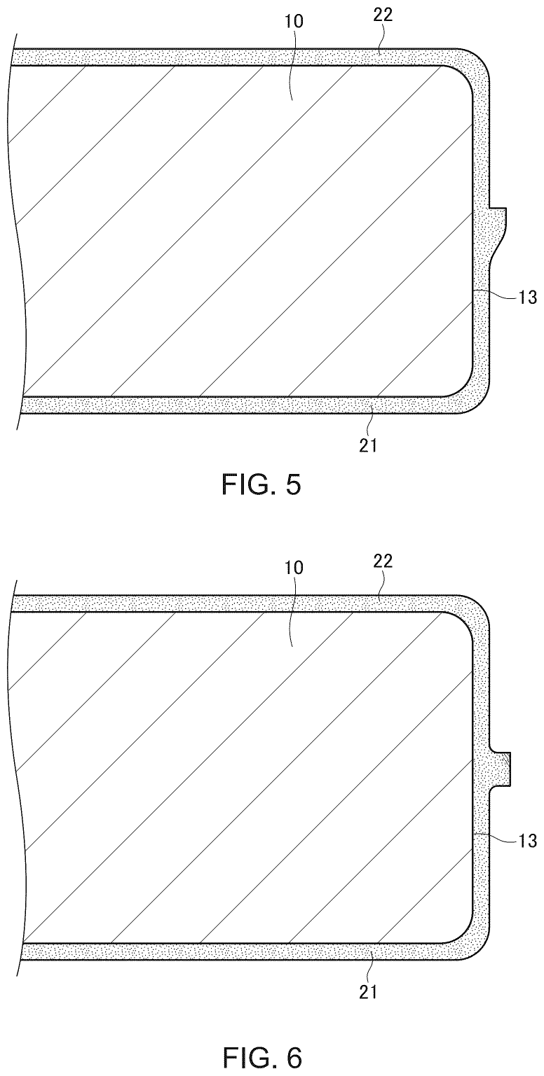

For example, when parts of the first and third resin regions 21 and 23 that cover the first side surface region 13A of the side surface 13 are formed integrally, and parts of the second and third resin regions 22 and 23 that cover the second side surface region 13B of the side surface 13 are formed integrally, the first and second resin regions 21 and 22 of the resin regions 21 and 22 may be connected so as to overlap each other on the side surface 13 as illustrated in FIG. 5, or the end portions of the first and second resin regions that have been bent outward may be connected to each other as illustrated in FIG. 6.

The technology according to the present disclosure includes the following configuration examples but not limited thereto.

A coil component according to an embodiment of the present disclosure includes: a ferrite sintered body having a first main surface, a second main surface positioned on the opposite side of the first main surface, and a side surface connecting the outer peripheral edges of the first and second main surfaces; a coil conductor disposed so as to overlap the first main surface of the ferrite sintered body; and a resin layer covering the first and second main surfaces and at least a part of the side surface. With this configuration, the diffusion of the ferrite particles can be suppressed.

In the above coil component, the resin layer may have a first resin region covering the first main surface of the ferrite sintered body, a second resin region covering the second main surface of the ferrite sintered body, and a third resin region covering the side surface of the ferrite sintered body, and the first and second resin regions may be connected to each other through the third resin region. This can suppress the diffusion of the ferrite particles more effectively.

In the above coil component, the first main surface, the second main surface, and the side surface of the ferrite sintered body may be entirely covered with the resin layer. This prevents the diffusion of the ferrite particles.

In the above coil component, the resin layer may contain a filler particle. This enhances the strength of the resin layer. In this case, the filler particle may contain a magnetic material. This makes the ferrite sintered body and resin layer entirely function as a magnetic path for magnetic flux, thus increasing the inductance of the coil conductor.

In the above coil component, the thickness of the resin layer may be smaller than the thickness of the ferrite sintered body. This can reduce the entire thickness while achieving high inductance.

In the above coil component, the resin layer may include a portion positioned between the first main surface of the ferrite sintered body and coil conductor. This enables communication with an external device disposed on the first main surface side of the ferrite sintered body and allows a substrate including a metal material to be disposed on the second main surface side of the ferrite sintered body.

In the above coil component, the coil conductor may be embedded in the resin layer. This can further reduce the entire thickness.

In the above coil component, the coil conductor may include a seed part containing resin and having first and second surfaces positioned on mutually opposite sides and a main body part stacked on the second surface of the seed part and constituted by a metal material, and the coil conductor may be embedded in the resin layer such that the first surface of the seed part is exposed from the resin layer. With this configuration, the main body part constituted by a metal material is protected by the seed layer exposed outside.

In the above coil component, the ferrite sintered body may have a first through hole, a part of the resin layer that covers the first main surface of the ferrite sintered body may have a second through hole, a part of the resin layer that covers the second main surface of the ferrite sintered body may have a third through hole, and the first, second, and third through holes may overlap an end portion of the coil conductor. This allows connection to the coil conductor from the second main surface side of the ferrite sintered body.

What is claimed is:

1. A coil component comprising:
a ferrite sintered body having a first main surface, a second main surface positioned on an opposite side of the first main surface, and a side surface connecting an outer peripheral edges of the first and second main surfaces;
a coil conductor disposed so as to overlap the first main surface of the ferrite sintered body; and
a resin layer covering the first and second main surfaces and at least a part of the side surface.

2. The coil component as claimed in claim 1,
wherein the resin layer has a first resin region covering the first main surface of the ferrite sintered body, a second resin region covering the second main surface of the ferrite sintered body, and a third resin region covering the side surface of the ferrite sintered body, and
wherein the first and second resin regions are connected to each other through the third resin region.

3. The coil component as claimed in claim 1, wherein the first main surface, the second main surface, and the side surface of the ferrite sintered body are entirely covered with the resin layer.

4. The coil component as claimed in claim 1, wherein the resin layer contains a filler particle.

5. The coil component as claimed in claim 4, wherein the filler particle contains a magnetic material.

6. The coil component as claimed in claim 1, wherein a thickness of the resin layer is smaller than a thickness of the ferrite sintered body.

7. The coil component as claimed in claim 1, wherein the resin layer includes a portion positioned between the first main surface of the ferrite sintered body and coil conductor.

8. The coil component as claimed in claim 7, wherein the coil conductor is embedded in the resin layer.

9. The coil component as claimed in claim 8,
wherein the coil conductor includes a seed part containing resin and having first and second surfaces positioned on mutually opposite sides and a main body part stacked on the second surface of the seed part and constituted by a metal material, and
wherein the coil conductor is embedded in the resin layer such that the first surface of the seed part is exposed from the resin layer.

10. The coil component as claimed in claim 7,
wherein the ferrite sintered body has a first through hole,
wherein a part of the resin layer that covers the first main surface of the ferrite sintered body has a second through hole,
wherein a part of the resin layer that covers the second main surface of the ferrite sintered body has a third through hole, and
wherein the first, second, and third through holes overlap an end portion of the coil conductor.
